(19) United States
(12) Patent Application Publication
(10) Pub. No.: US 2026/0072744 A1
(43) Pub. Date: Mar. 12, 2026

(54) SYSTEMS AND METHODS FOR RESOURCE TOKENIZATION USING ADVANCED COMPUTATIONAL MODELS FOR DATA ANALYSIS AND AUTOMATED PROCESSING

(71) Applicant: BANK OF AMERICA CORPORATION, CHARLOTTE, NC (US)

(72) Inventors: Pratap Dande, Saint Johns, FL (US); Brian Jacobson, Granada Hills, CA (US); Rahul Yaksh, Austin, TX (US); Noell Y. Eury, Stanfield, NC (US); Bojan Zdravkovic, Jersey City, NJ (US); Tony Aidoo, Aubrey, TX (US); Dennis Vranjesevic, Kent Cliffs, NY (US)

(73) Assignee: BANK OF AMERICA CORPORATION, CHARLOTTE, NC (US)

(21) Appl. No.: 18/830,255

(22) Filed: Sep. 10, 2024

(51) Int. Cl. G06F 9/50

(52) U.S. Cl. CPC G06F 9/5027

(57) ABSTRACT

Systems, computer program products, and methods are described herein for resource tokenization using advanced computational models for data analysis and automated processing. The present disclosure is configured to receive a resource from a distributed network, wherein the distributed network is configured to digitize the resource. Further, the present disclosure is configured to execute a smart contract, wherein the smart contract is configured to automate execution of an agreement. Further still, the present disclosure is configured to transmit a notification to a user device to provide real-time access to the resource and resource data. Further still, the present disclosure is configured to configure, via an ownership engine, the resource data, wherein the ownership engine provides ownership transfers based on the agreement. Further still, the present disclosure is configured to implement, via an implementation engine, the resource on the distributed network.

### TECHNOLOGICAL FIELD

Example embodiments of the present disclosure relate to systems and methods for resource tokenization using advanced computational models for data analysis and automated processing.

### BACKGROUND

There are significant challenges associated with conventional management of resources in a distributed network. Applicant has identified a number of deficiencies and problems associated with conventional resource tracking and management systems. Through applied effort, ingenuity, and innovation, many of these identified problems have been solved by developing solutions that are included in embodiments of the present disclosure, many examples of which are described in detail herein.

### BRIEF SUMMARY

The following presents a simplified summary of one or more embodiments of the present disclosure, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present disclosure in a simplified form as a prelude to the more detailed description that is presented later.

Systems, methods, and computer program products are provided for resource tokenization using advanced computational models for data analysis and automated processing.

Embodiments of the present invention address the above needs and/or achieve other advantages by providing apparatuses (e.g., a system, computer program product, and/or other devices) and methods for resource tokenization using advanced computational models for data analysis and automated processing. The system embodiments may comprise a processing device and a non-transitory storage device containing instructions when executed by the processing device, to perform the steps disclosed herein. In computer program product embodiments of the invention, the computer program product comprises a non-transitory computer-readable medium comprising code causing an apparatus to perform the steps disclosed herein. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the steps disclosed herein.

In some embodiments, the present invention may include a distributed network configured to digitize a resource and resource data comprising ownership details of the resource, a value of the resource, and a transaction history of the resource. Further, in some embodiments, the present invention may include a smart contract configured to automate execution of an agreement associated with the resource. Further, in some embodiments, the present invention may include a user device comprising an interface, wherein the interface provides real-time access to the resource and resource data. Further, in some embodiments, the present invention may include an ownership engine configured to provide ownership transfers of the resource based on the agreement. Further, in some embodiments, the present invention may include an implementation engine configured to verify configurations associated with the ownership engine. Further, in some embodiments, the present invention may receive the resource from the distributed network, execute the smart contract, transmit a notification to the user device, configure, via the ownership engine, the resource data, and implement, via the implementation engine, the resource onto the distributed network.

In some embodiments, the smart contract is configured to automatically enforce terms of the agreement, wherein the agreement comprises distributing the resource to a beneficiary based on predetermined conditions associated with the smart contract.

In some embodiments, a tokenization process divides the resource into one or more fractional shares, enabling one or more parties to own the one or more fractional shares.

In some embodiments, the ownership engine enables the one or more parties to exchange the one or more fractional shares, and wherein the ownership engine comprises interoperability with an additional distributed network, wherein the additional distributed network comprises a different platform.

In some embodiments, the interface is configured to configure the user device, and wherein the interface comprises displaying the resource data in real-time.

In some embodiments, the interface comprises transmitting a notification to the user device, wherein the notification is associated with a significant event associated with the resource.

In some embodiments, the resource is associated with a trust.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for resource tokenization using advanced computational models for data analysis and automated processing, in accordance with an embodiment of the disclosure;

FIG. 2 illustrates a process flow for resource tokenization using advanced computational models for data analysis and automated processing, in accordance with an embodiment of the disclosure; and

FIG. 3 illustrates an example embodiment for resource tokenization using advanced computational models for data analysis and automated process, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of an application, or part of an application that serves as a foundation for a larger piece of software and drives the functionality of the software. In some embodiments, an engine may be self-contained, but externally-controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “resource” may generally refer to objects, products, devices, goods, commodities, services, and the like, and/or the ability and opportunity to access and use the same. Some example implementations herein contemplate property held by a user, including property that is stored and/or maintained by a third-party entity. In some example implementations, a resource may be associated with one or more accounts or may be property that is not associated with a specific account. Examples of resources associated with accounts may be accounts that have cash or cash equivalents, commodities, and/or accounts that are funded with or contain property, such as safety deposit boxes containing jewelry, art or other valuables, a trust account that is funded with property, or the like. For purposes of this disclosure, a resource is typically stored in a resource repository-a storage location where one or more resources are organized, stored and retrieved electronically using a computing device.

As used herein, a “transfer,” a “distribution,” and/or an “allocation” may refer to any transaction, activities or communication between one or more entities, or between the user and the one or more entities. A resource transfer may refer to any distribution of resources such as, but not limited to, a payment, processing of funds, purchase of goods or services, a return of goods or services, a payment transaction, a credit transaction, or other interactions involving a user's resource or account. Unless specifically limited by the context, a “resource transfer” a “transaction”, “transaction event” or “point of transaction event” may refer to any activity between a user, a merchant, an entity, or any combination thereof. In some embodiments, a resource transfer or transaction may refer to financial transactions involving direct or indirect movement of funds through traditional paper transaction processing systems (i.e. paper check processing) or through electronic transaction processing systems. Typical financial transactions include point of sale (POS) transactions, automated teller machine (ATM) transactions, person-to-person (P2P) transfers, internet transactions, online shopping, electronic funds transfers between accounts, transactions with a financial institution teller, personal checks, conducting purchases using loyalty/rewards points etc. When discussing that resource transfers or transactions are evaluated, it could mean that the transaction has already occurred, is in the process of occurring or being processed, or that the transaction has yet to be processed/posted by one or more financial institutions. In some embodiments, a resource transfer or transaction may refer to non-financial activities of the user. In this regard, the transaction may be a customer account event, such as but not limited to the customer changing a password, ordering new checks, adding new accounts, opening new accounts, adding or modifying account parameters/restrictions, modifying a payee list associated with one or more accounts, setting up automatic payments, performing/modifying authentication procedures and/or credentials, and the like.

As used herein, “payment instrument” may refer to an electronic payment vehicle, such as an electronic credit or debit card. The payment instrument may not be a “card” at all and may instead be account identifying information stored electronically in a user device, such as payment credentials or tokens/aliases associated with a digital wallet, or account identifiers stored by a mobile application.

In the modern world, management, tracking, digitization, and tokenization of resources present significant challenges. Specifically, when the resources are related to trust resources, mandated requirements for management of trust portfolios consume significant resources. Many trust accounting tasks are performed manually, which are prone to errors, inefficiencies, and increases the chance of inaccuracies in accounting records and financial statements. These accounting tasks may include data entry, reconciliation, reporting, distributions, and the like. Relying upon manual processes for such sensitive data increases the chances of misappropriations through unauthorized access, breach, and/or cyber misappropriations. Therefore, systems and methods for resource tokenization using advanced computational models for data analysis and automated processing are introduced.

The system 130 as described herein may include digitizing a resource by way of capturing the resource and digitally recording the resource. This may include digital photographs of the resource, digitizing records of the resource, or other digital storage of the resource. For example, a real estate parcel may be digitized via digitally recording the deed associated with the parcel. Further, the resource may be tokenized in order to fraction (e.g., split) the resource into one or more tokens to allow for multiple parties to own the resource. For example, the real estate parcel tokens may be owned by one or more parties. These tokens may be stored on a distribute network, such as a blockchain.

Further, transfers of ownership, distributions, or the like, of the tokens may be performed via a smart contract. In this regard, an agreement (e.g., a distribution agreement) may include terms on the details of distributing the tokens to beneficiaries, for example. In this example, a trust (e.g., agreement) may set out distribution terms, which may be coded into a smart contract, wherein the tokens are distributed upon a certain date to beneficiaries of the trust. The smart contract may automatically distribute the tokens to the beneficiaries upon the date set in the terms of the agreement.

In addition, an ownership engine may perform and record the smart contract's distributions. The ownership engine may also perform and record transfers of ownership of the tokens. For example, users wishing to buy, sell, or otherwise trade the tokens may transact via the ownership engine. In this regard, the ownership engine may transfer ownership of the tokens and record such transfers. Further, an implementation engine may implement the updated status of the tokens to the blockchain. For example, the ownership engine's transfer of ownership may be transmitted to the implementation engine, whereby the implementation engine verifies such transaction and updates it to the blockchain. Further still, significant events (e.g., distributions, transfers of ownership, etc.) of the resource and/or tokens may be transmitted to a user device via a notification. In this way, the user device may provide real-time updates to the status of the resource and associated resource data.

What is more, the present disclosure provides a technical solution to a technical problem. As described herein, the technical problem includes manual processes associated with the management of trust resources, such as records of trust resources, distributions of trust resources, transfers of ownership, and the like. The technical solution presented herein allows for digitizing and tokenizing trust resources for them to be managed on a distributed network and for smart contracts to automatically distribute resources to beneficiaries. In particular, the tokenization system (e.g., the system 130 as described herein) is an improvement over existing solutions to conventional systems'management of trust resources, (i) with fewer steps to achieve the solution, thus reducing the amount of computing resources, such as processing resources, storage resources, network resources, and/or the like, that are being used (e.g., by using smart contracts to automatically execute distributions of the resource), (ii) providing a more accurate solution to problem, thus reducing the number of resources required to remedy any errors made due to a less accurate solution (e.g., by accurately and effectively managing trust resources via a distributed network), (iii) removing manual input and waste from the implementation of the solution, thus improving speed and efficiency of the process and conserving computing resources (e.g., by automating transfers of ownership, distributions of resources, and recordation of such activities through the use of smart contracts), (iv) determining an optimal amount of resources that need to be used to implement the solution, thus reducing network traffic and load on existing computing resources (e.g., by digitizing and tokenizing resources in order to facilitate effective management of resources to reduce manual input to the management of such resources). Furthermore, the technical solution described herein uses a rigorous, computerized process to perform specific tasks and/or activities that were not previously performed. In specific implementations, the technical solution bypasses a series of steps previously implemented, thus further conserving computing resources.

In addition, the technical solution described herein is an improvement to computer technology and is directed to non-abstract improvements to the functionality of a computer platform itself. Specifically, the tokenization system as described herein is a solution to the problem of manually managing, updating, tracking, and the like, trust resources. Further, the tokenization system may be characterized as identifying a specific improvement in computer capabilities and/or network functionalities in response to the tokenization system's integration to existing devices, software, applications, and/or the like. In this way, the tokenization system improves the capability of a system to effectively manage resources of a trust by way of automatic distributions and ownership transfers. Further, the tokenization system improves the functionality of networks in response to reducing the resources consumed by the system (e.g., network resources, computing resources, memory resources, and/or the like).

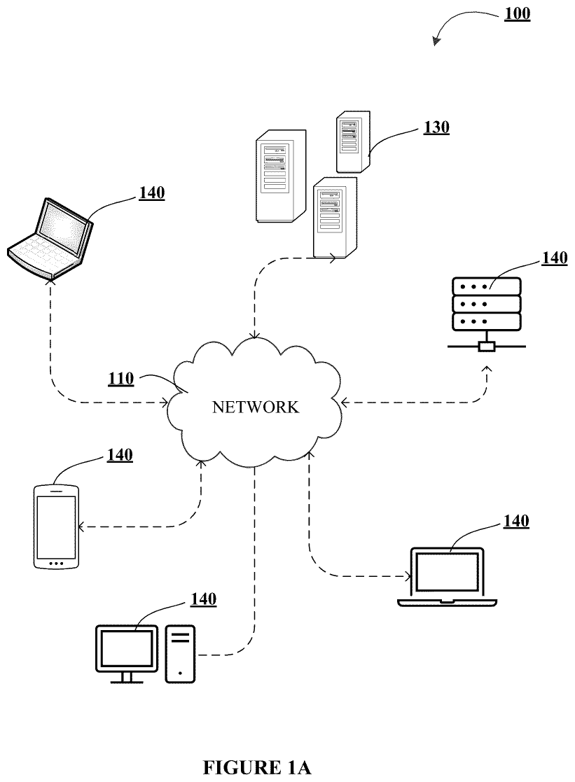

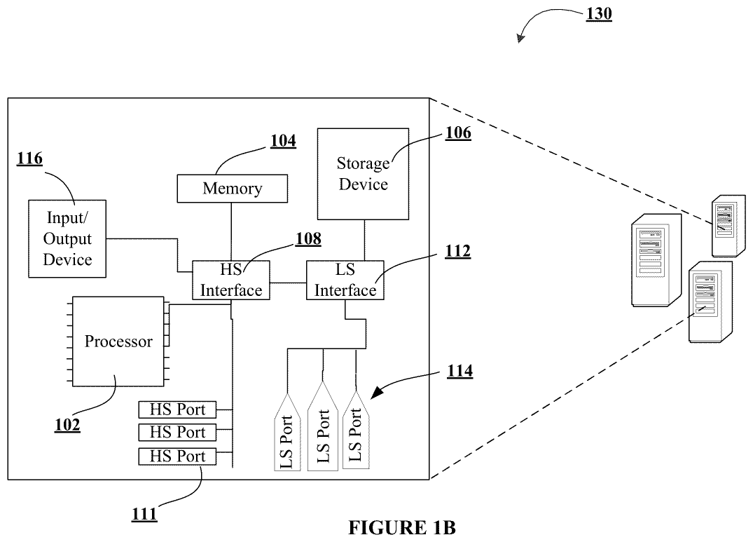

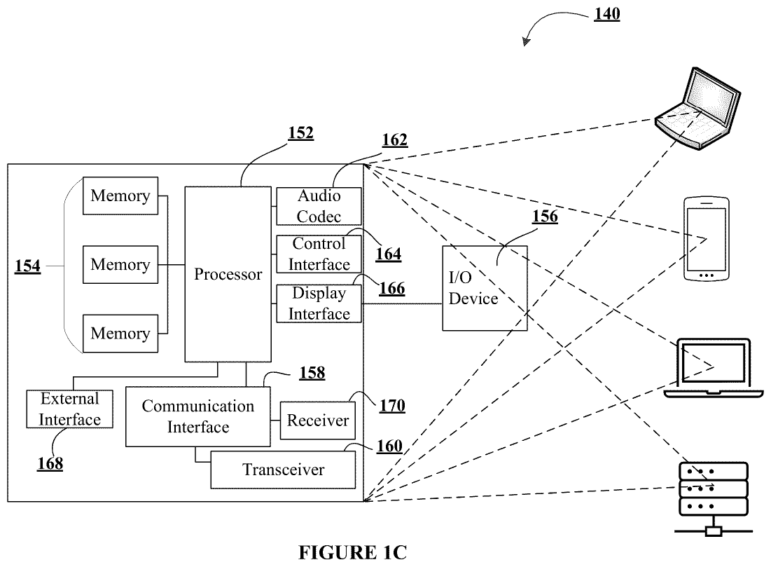

FIGS. 1A-1C illustrate technical components of an exemplary distributed computing environment 100 for resource tokenization using advanced computational models for data analysis and automated processing, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server (e.g., system 130). In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, resource distribution devices, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. In some embodiments, the network 110 may include a telecommunication network, local area network (LAN), a wide area network (WAN), and/or a global area network (GAN), such as the Internet. Additionally, or alternatively, the network 110 may be secure and/or unsecure and may also include wireless and/or wired and/or optical interconnection technology. The network 110 may include one or more wired and/or wireless networks. For example, the network 110 may include a cellular network (e.g., a long-term evolution (LTE) network, a code division multiple access (CDMA) network, a 3G network, a 4G network, a 5G network, another type of next generation network, and/or the like), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion, or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, storage device 106, a high-speed interface 108 connecting to memory 104, high-speed expansion points 111, and a low-speed interface 112 connecting to a low-speed bus 114, and an input/output (I/O) device 116. The system 130 may also include a high-speed interface 108 connecting to the memory 104, and a low-speed interface 112 connecting to low-speed port 114 and storage device 106. Each of the components 102, 104, 106, 108, 111, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system. The processor 102 may process instructions for execution within the system 130, including instructions stored in the memory 104 and/or on the storage device 106 to display graphical information for a GUI on an external input/output device, such as a display 116 coupled to a high-speed interface 108. In some embodiments, multiple processors, multiple buses, multiple memories, multiple types of memory, and/or the like may be used. Also, multiple systems, same or similar to system 130, may be connected, with each system providing portions of the necessary operations (e.g., as a server bank, a group of blade servers, a multi-processor system, and/or the like). In some embodiments, the system 130 may be managed by an entity, such as a business, a merchant, a financial institution, a card management institution, a software and/or hardware development company, a software and/or hardware testing company, and/or the like. The system 130 may be located at a facility associated with the entity and/or remotely from the facility associated with the entity.

The processor 102 can process instructions, such as instructions of an application that may perform the functions disclosed herein. These instructions may be stored in the memory 104 (e.g., non-transitory storage device) or on the storage device 106, for execution within the system 130 using any subsystems described herein. It is to be understood that the system 130 may use, as appropriate, multiple processors, along with multiple memories, and/or I/O devices, to execute the processes described herein.

The memory 104 may store information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation. The memory 104 may store any one or more of pieces of information and data used by the system in which it resides to implement the functions of that system. In this regard, the system may dynamically utilize the volatile memory over the non-volatile memory by storing multiple pieces of information in the volatile memory, thereby reducing the load on the system and increasing the processing speed.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 106, or memory on processor 102.

In some embodiments, the system 130 may be configured to access, via the network 110, a number of other computing devices (not shown). In this regard, the system 130 may be configured to access one or more storage devices and/or one or more memory devices associated with each of the other computing devices. In this way, the system 130 may implement dynamic allocation and de-allocation of local memory resources among multiple computing devices in a parallel and/or distributed system. Given a group of computing devices and a collection of interconnected local memory devices, the fragmentation of memory resources is rendered irrelevant by configuring the system 130 to dynamically allocate memory based on availability of memory either locally, or in any of the other computing devices accessible via the network. In effect, the memory may appear to be allocated from a central pool of memory, even though the memory space may be distributed throughout the system. Such a method of dynamically allocating memory provides increased flexibility when the data size changes during the lifetime of an application and allows memory reuse for better utilization of the memory resources when the data sizes are large.

The high-speed interface 108 manages bandwidth-intensive operations for the system 130, while the low-speed interface 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed interface 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router (e.g., through a network adapter).

The system 130 may be implemented in a number of different forms. For example, the system 130 may be implemented as a standard server, or multiple times in a group of such servers. Additionally, the system 130 may also be implemented as part of a rack server system or a personal computer (e.g., laptop computer, desktop computer, tablet computer, mobile telephone, and/or the like). Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 156, 158, 160, 162, 164, 166, 168 and 170, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor 152 may be implemented as a chipset of chips that include separate and multiple analog and digital processors. The processor 152 may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156 (e.g., input/output device 156). The display 156 may be, for example, a Thin-Film-Transistor Liquid Crystal Display (TFT LCD) or an Organic Light Emitting Diode (OLED) display, or other appropriate display technology. An interface of the display may include appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a Single In Line Memory Module (SIMM) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner. In some embodiments, the user may use applications to execute processes described with respect to the process flows described herein. For example, one or more applications may execute the process flows described herein. In some embodiments, one or more applications stored in the system 130 and/or the user input system 140 may interact with one another and may be configured to implement any one or more portions of the various user interfaces and/or process flow described herein.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as GSM voice calls, SMS, EMS, or MMS messaging, CDMA, TDMA, PDC, WCDMA, CDMA2000, GPRS, and/or the like. Such communication may occur, for example, through transceiver 160. Additionally, or alternatively, short-range communication may occur, such as using a Bluetooth, Wi-Fi, near-field communication (NFC), and/or other such transceiver (not shown). Additionally, or alternatively, a Global Positioning System (GPS) receiver module 170 may provide additional navigation-related and/or location-related wireless data to user input system 140, which may be used as appropriate by applications running thereon, and in some embodiments, one or more applications operating on the system 130.

Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed application specific integrated circuits (ASICs), computer hardware, firmware, software, and/or combinations thereof.

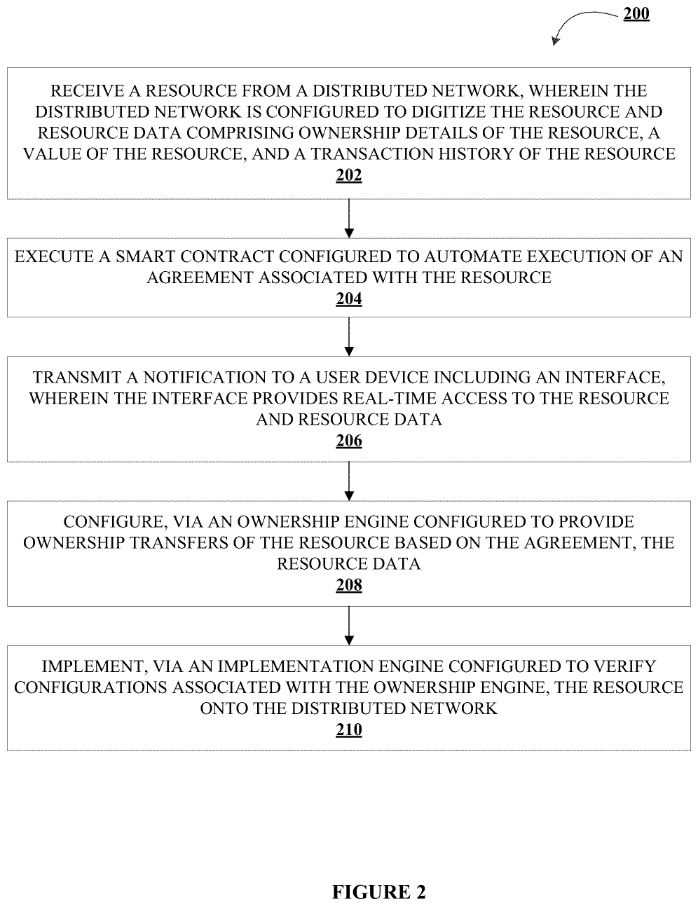

FIG. 2 illustrates a process flow for resource tokenization using advanced computational models for data analysis and automated processing, in accordance with an embodiment of the disclosure. The method may be carried out by various components of the distributed computing environment 100 discussed herein (e.g., the system 130, one or more end-point device(s) 140, etc.). An example system may include at least one processing device and at least one non-transitory storage device with computer-readable program code stored thereon and accessible by the at least one processing device, wherein the computer-readable code when executed is configured to carry out the method discussed herein.

In some embodiments, a tokenization system (e.g., similar to one or more of the systems described herein with respect to FIGS. 1A-1C) may perform one or more of the steps of process flow 200. For example, a tokenization system (e.g., the system 130 described herein with respect to FIGS. 1A-1C) may perform the steps of process flow 200.

As shown in block 202, the process flow 200 of this embodiment includes receiving a resource from a distributed network, wherein the distributed network is configured to digitize the resource and resource data including ownership details of the resource, a value of the resource, and a transaction history of the resource.

In some embodiments, the resource is associated with a trust. The resource may be associated with a trust, which may include a trustor, a trustee, one or more beneficiaries, and the like. The trustor may be an individual, an entity, or the like that opens or creates the trust. The trustee may manage the trust and associated trust resources, and may be appointed by the trustor to perform such management. The beneficiary or beneficiaries may be individuals who benefit from the trust, or, in other words, receive distributions, transfers, payouts, or the like in the form of trust resources from the trust. The resource (e.g., trust resource) may include tangible or intangible resources, resources, or the like. In this regard, the resource may include resources, as discussed in greater detail above. As a non-limiting example, the resource may include a resource such as real estate, gold, securities, personal property, business interests, insurance policies, intellectual property, or the like. In conventional systems, the trustee typically manages the trust through manual operations. For example, a trustee of a conventional trust may manually authorize or initiate trust distributions to a beneficiary. In some embodiments, the system as described herein may automate the process of managing the trust by way of digitizing and tokenizing trust resources for them to be automatically managed via smart contracts.

In some embodiments, the tokenization system (e.g., the system 130 as described herein) may include a tokenization process, wherein the tokenization process divides the resource into one or more fractional shares, enabling one or more parties to own the one or more fractional shares. The tokenization process may include converting resources into digital tokens that may be used on a distributed network, distributed ledger, blockchain, or other digital platforms. Tokenizing resources, such as trust resources, may allow for greater liquidity and ease in transferring, distributing, and managing the trust resources.

Initially, and in some embodiments, the tokenization process may include identifying the resource to be tokenized. This may include locating, recording, tracking, or otherwise identifying the resource by way of ledgers, public records, private records, or the like. For example, if a piece of real estate is to be tokenized, the system may use a public records database to locate and record the resource. In this regard, the system may search and analyze public records to find data relating to transfers, sales, and the like of the real estate. In another non-limiting example, if the resource includes resources such as gold, the identification and tracking procedures may include initially locating the gold resources, providing records that attest to ownership of the gold resources, comparing identification marks on the gold resources with those found in the attestation records, and so forth. In some embodiments, the tracking and identification process may involve manual contributions or input to the system 130.

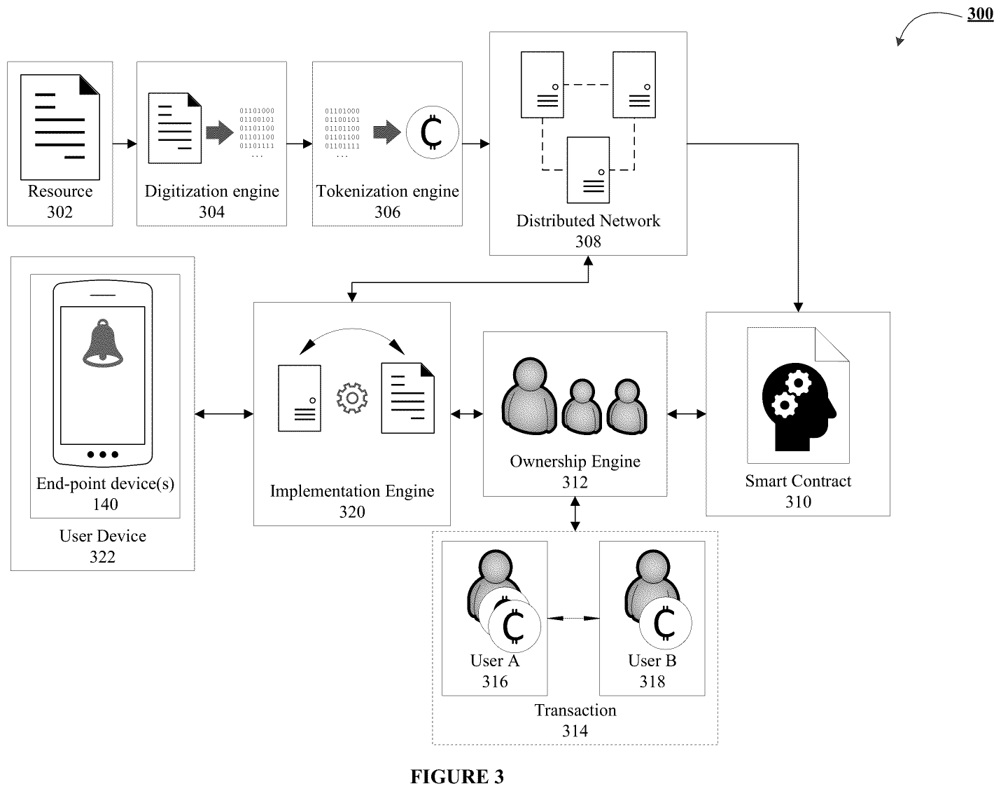

In some embodiments, the system may digitize the resource. For example, as shown in FIG. 3, the resource 302 may be digitized in a digitization engine 304. In some embodiments, digitizing the resource 302 may include converting the resource 302 into a digital format, or digital representation of the resource. The digitization may create a digital version of the resource 302, which makes it easier to store, access, and manage by the system 130. Initially, the digitization process may include capturing, via the digitization engine 304 for example, the data associated with the resource 302, such as scanning, photographing, creating digital records of ownership, or the like. In this regard, capturing the data of the resource 302 may include digitally inputting the resource 302 and associated resource data into the system 130. For example, a deed associated with a real estate resource (e.g., the resource 302) may be scanned and digitized via the digitization engine 304, which may be stored in a digital land registry.

In some embodiments, the digitization engine 304 may store the digital version of the resource 302 by way of electronic databases, registries, distributed networks, platforms, or the like. For example, in some embodiments, the digitization engine 304 may store the resource in a distributed network 308. The resource 302 (e.g., digitized resource) may then be used by the system 130, a tokenization engine 306, or the like.

In some embodiments, the tokenization engine 306 may include creating one or more digital tokens that represent ownership in the resource 302. The tokens may be tradable, transferable, and manageable within the system 130 or a distributed network 308. In this regard, the tokenized resource 302 may be fractioned to create one or more tokens that may be owned by one or more individuals or beneficiaries of the resource 302. The tokenization engine 306 may identify which resource 302 needs to be tokenized by using the digitization engine 304. For example, the resource 302 may be digitized by the digitization engine 304 and, subsequently, the tokenization engine 306 may begin the tokenization process.

In some embodiments, the tokenization engine 306 will create one or more tokens that represent the resource 302. The tokenization engine 306 may use the distributed network 308 to create the tokens. In some embodiments, the tokens may be created using standards, policies, or regulations associated with the resource 302. In this regard, the tokens may follow standards that allow for certain functionalities, interoperability with other distributed networks, or the like. The functionalities may include determining fungibility status (e.g., equality and valuation of each token), associated metadata, ownership status, and the like. In some embodiments, the standards used to create the tokens may be based upon the resource 302 itself (e.g., the resource class), a designation of the trust or trustee, the agreement, or the like.

In some embodiments, the ownership engine may enable the one or more parties to exchange the one or more fractional shares, and wherein the ownership engine includes interoperability with an additional distributed network, wherein the additional distributed network includes a different platform. In this regard, the fractional shares (i.e., tokens of the resource 302) may interoperate with an additional distributed network. The additional distributed network may communicate with the distributed network 308 to transfer and access the tokens. The additional distributed network may include a different platform than the distributed network 308.

In some embodiments, the system 130 may store the tokens of the resource 302 in a distributed network 308. The distributed network 308 may include a distributed ledger, blocks, and a consensus mechanism. The distributed network 308 may include a blockchain or the like where the tokens are stored and can be accessed by the system 130 or an additional distributed network. In some embodiments, the additional distributed network may include a network built with the same, similar, or different languages (e.g., coding languages) from the distributed network 308.

As shown in block 204, the process flow 200 of this embodiment includes executing a smart contract configured to automate execution of an agreement associated with the resource. In some embodiments, the smart contract 310 may include features such as being self-executable, immutable, transparent, deterministic, and the like. In this regard, the smart contract 310 may include code that contains terms and conditions of the agreement associated with the resource 302. The agreement's terms may be written into the smart contract 310 where the agreement's terms may be executed once conditions are met. For example, the agreement may include terms to distribute the resource 302 to a beneficiary. The smart contract 310 may then manage the distribution of the resource 302 after it has been digitized and tokenized by distributing the resource 302 to the beneficiary. In a specific example, the agreement may include terms to distribute the resource 302 to a beneficiary on a periodic basis, such as once a month.

In some embodiments, the smart contract is configured to automatically enforce terms of the agreement, wherein the agreement includes distributing the resource to a beneficiary based on predetermined conditions associated with the smart contract.

As shown in block 206, the process flow 200 of this embodiment includes transmitting a notification to a user device including an interface, wherein the interface provides real-time access to the resource and resource data. In some embodiments, the interface includes transmitting a notification to the user device, wherein the notification is associated with a significant event associated with the resource.

In some embodiments, the user device may include the end-point device(s) 140 as shown in FIG. 1A-1C. For example, as shown in FIG. 3, the user device 322 may include an end-point device 140. In this regard, the user device 322 may have the same or similar components as the end-point device 140 as shown in FIG. 1A-1C. The user device 322 may provide real-time access to the resource 302 and associated resource data by way of communicating with the distributed network 308, the implementation engine 320, the ownership engine 312, or the system 130 in general. In this way, the user device 322 may display or provide information to a user who has an interest in the resource 302 within the system 130. For example, if the user is a beneficiary of the resource 302, the user device 322 may provide real-time updates relating to the resource 302, any distributions of the resource 302 that may have occurred or are scheduled to occur, the resource's 302 value, the ownership status of the resource 302, or the like.

Further, in some embodiments, if a significant event occurs relating to the resource 302, the system 130 may generate a notification and transmit the notification to the user device 322. By way of non-limiting example, and as shown in FIG. 3, if the implementation engine 320 implements the resource 302 onto the distributed network 308, the implementation of the resource 302 may be interpreted as a significant event. The determination of the what a significant event includes may be defined by the user, the system 130, an administrator of the system 130, the trustee, or the like. Further, other significant events may include a transfer of ownership, whereby the ownership engine 312 may produce a notification transmitted to the user device 322. Further, the smart contract 310 may, upon execution, transmit a notification to the user device 322 including updates as to how the resource 302 was affected during execution of the smart contract 310. In this regard, the notifications transmitted to the user device 322 may provide the user with continuous, real-time information associated with the resource 302 or the resource data.

As shown in block 208, the process flow 200 of this embodiment includes configuring, via an ownership engine configured to provide ownership transfers of the resource based on the agreement, the resource data. In some embodiments, as shown in FIG. 3, the ownership engine 312 may provide for transferring ownership of the resource 302. The tokens associated with the resource 302 may be transferred between one or more users, beneficiaries, individuals, entities, or the like. For example, a transaction 314 may include a user A 316 and a user B 318, wherein the users are transferring ownership of the resource 302 tokens. In this regard, the tokens may be stored on the distributed network 308 and may have smart contracts 310 associated with them that allow for the transfer of ownership based upon certain valuations. In other words, when a user (e.g., user B) wishes to acquire ownership of a token, the user B may transfer resources to another user (e.g., user A) to trade such tokens. The ownership engine 312 may facilitate such transfer of ownership in the tokens, and may report out the transfer of ownership to the system 130, the implementation engine 320, and/or the user device 322.

In some embodiments, the ownership engine 312 may be used to distribute the resource 302 to the beneficiary. In this regard, the terms of the distributions of the tokens may be coded or written into the smart contract 310. Further, the smart contract 310, upon execution, may distribute the resource 302 (e.g., tokens) to the beneficiary. Notifications of such distributions may also be transmitted to the user device 322 associated with the beneficiary, trustee, and the like.

As shown in block 210, the process flow 200 of this embodiment includes implementing, via an implementation engine configured to verify configurations associated with the ownership engine, the resource onto the distributed network. In some embodiments, the implementation engine 320 may implement the resource 302 distributions, transfers of ownership, valuations, or the like onto the distributed network 308. In this way, any updates to the resource 302 or the resource data may be registered, recorded, and updated via the implementation engine 320. The implementation engine 320 may communicate with the distributed network 308 to update the associated tokens stored on the distributed network 308, which may include updating ownership, valuations, transaction history, or the like. For example, upon the transaction 314 being completed, the implementation engine 320 may update the tokens'ownership status on the distributed network 308.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for resource tokenization using advanced computational models for data analysis and automated processing, the system comprising:
a distributed network configured to digitize a resource and resource data comprising ownership details of the resource, a value of the resource, and a transaction history of the resource;
a smart contract configured to automate execution of an agreement associated with the resource;
a user device comprising an interface, wherein the interface provides real-time access to the resource and resource data;
an ownership engine configured to provide ownership transfers of the resource based on the agreement;
an implementation engine configured to verify configurations associated with the ownership engine;
a processing device; and
a non-transitory storage device containing instructions when executed by the processing device, causes the processing device to perform the steps of:
receive the resource from the distributed network;
execute the smart contract;
transmit a notification to the user device;
configure, via the ownership engine, the resource data; and
implement, via the implementation engine, the resource onto the distributed network.

2. The system of claim 1, wherein the smart contract is configured to automatically enforce terms of the agreement, wherein the agreement comprises distributing the resource to a beneficiary based on predetermined conditions associated with the smart contract.

3. The system of claim 1, wherein a tokenization process divides the resource into one or more fractional shares, enabling one or more parties to own the one or more fractional shares.

4. The system of claim 3, wherein the ownership engine enables the one or more parties to exchange the one or more fractional shares, and wherein the ownership engine comprises interoperability with an additional distributed network, wherein the additional distributed network comprises a different platform.

5. The system of claim 1, wherein the interface is configured to configure the user device, and wherein the interface comprises displaying the resource data in real-time.

6. The system of claim 1, wherein the interface comprises transmitting a notification to the user device, wherein the notification is associated with a significant event associated with the resource.

7. The system of claim 1, wherein the resource is associated with a trust.

8. A computer program product for resource tokenization using advanced models for data analysis and automated processing, the computer program product comprising a non-transitory computer-readable medium comprising code causing an apparatus to:
receive a resource from a distributed network, wherein the distributed network is configured to digitize the resource and resource data comprising ownership details of the resource, a value of the resource, and a transaction history of the resource;
execute a smart contract configured to automate execution of an agreement associated with the resource;
transmit a notification to a user device comprising an interface, wherein the interface provides real-time access to the resource and resource data;
configure, via an ownership engine configured to provide ownership transfers of the resource based on the agreement, the resource data; and
implement, via an implementation engine configured to verify configurations associated with the ownership engine, the resource onto the distributed network.

9. The computer program product of claim 8, wherein the smart contract is configured to automatically enforce terms of the agreement, wherein the agreement comprises distributing the resource to a beneficiary based on predetermined conditions associated with the smart contract.

10. The computer program product of claim 8, wherein a tokenization process divides the resource into one or more fractional shares, enabling one or more parties to own the one or more fractional shares.

11. The computer program product of claim 10, wherein the ownership engine enables the one or more parties to exchange the one or more fractional shares, and wherein the ownership engine comprises interoperability with an additional distributed network, wherein the additional distributed network comprises a different platform.

12. The computer program product of claim 8, wherein the interface is configured to configure the user device, and wherein the interface comprises displaying the resource data in real-time.

13. The computer program product of claim 8, wherein the interface comprises transmitting a notification to the user device, wherein the notification is associated with a significant event associated with the resource.

14. The computer program product of claim 8, wherein the resource is associated with a trust.

15. A method for resource tokenization using advanced computational models for data analysis and automated processing, the method comprising:
receiving a resource from a distributed network, wherein the distributed network is configured to digitize the resource and resource data comprising ownership details of the resource, a value of the resource, and a transaction history of the resource;
executing a smart contract configured to automate execution of an agreement associated with the resource;
transmitting a notification to a user device comprising an interface, wherein the interface provides real-time access to the resource and resource data;
configuring, via an ownership engine configured to provide ownership transfers of the resource based on the agreement, the resource data; and
implementing, via an implementation engine configured to verify configurations associated with the ownership engine, the resource onto the distributed network.

16. The method of claim 15, wherein the smart contract is configured to automatically enforce terms of the agreement, wherein the agreement comprises distributing the resource to a beneficiary based on predetermined conditions associated with the smart contract.

17. The method of claim 15, wherein a tokenization process divides the resource into one or more fractional shares, enabling one or more parties to own the one or more fractional shares.

18. The method of claim 17, wherein the ownership engine enables the one or more parties to exchange the one or more fractional shares, and wherein the ownership engine comprises interoperability with an additional distributed network, wherein the additional distributed network comprises a different platform.

19. The method of claim 15, wherein the interface is configured to configure the user device, and wherein the interface comprises displaying the resource data in real-time.

20. The method of claim 15, wherein the interface comprises transmitting a notification to the user device, wherein the notification is associated with a significant event associated with the resource.
